(19) United States
(12) Patent Application Publication
(10) Pub. No.: US 2023/0259877 A1
(43) Pub. Date: Aug. 17, 2023

(54) EQUIPMENT/SUPPLIES ORDERING, DELIVERY, AND CONFIGURATION SYSTEM

(71) Applicant: Xerox Corporation, Norwalk, CT (US)

(72) Inventors: Donald A. Brown, Honeoye Falls, NY (US); James D. Gresko, Rochester, NY (US)

(73) Assignee: Xerox Corporation, Norwalk, CT (US)

(21) Appl. No.: 17/671,716

(22) Filed: Feb. 15, 2022

(51) Int. Cl. G06Q 10/08

(52) U.S. Cl. CPC G06Q 10/087; G06Q 10/083

(57) ABSTRACT

A computer server receives office equipment rules of an organization. The office equipment rules include office equipment configuration settings. The computer server configures at least one office equipment application that satisfies the office equipment rules. The computer server supplies the office equipment application to at least one computerized device of at least one user associated with the organization. In return, the computer server receives an equipment/supplies order from the office equipment application. In response, the computer server generates order instructions. The order instructions include a list of equipment/supplies and the office equipment configuration settings for components on the list of equipment/supplies. The order instructions are generated to comply with the office equipment rules. Then, the computer server transmits the order instructions to a delivery and setup agent who delivers, configures, and sets up the equipment/supplies according to the order instructions.

### BACKGROUND

Systems and methods herein provide equipment and supplies to employees/agents of an organization and relate more particularly to an equipment/supplies ordering, delivery, and configuration methods and systems.

Organizations recognize that cost savings and employee productivity increases can be achieved by supplying office equipment that is both appropriate and properly configured. Many times, employees/agents of an organization self-determine, self-fulfill, and self-configure their office equipment. This is especially true for employees/agents that work remotely (e.g., out of their homes or at shared workspaces).

Because most employees/agents are not trained information technology (IT) engineers, the process of self-determining and self-configuring their own office equipment can be less that optimal, resulting in inappropriate/insufficient security, wasted employee time, inappropriate equipment being in place, equipment being underutilized, etc. Therefore, remote workers often lack access to quality office equipment that is correctly configured to their needs or that meets corporate security standards.

Standardization of equipment usage within an organization promotes IT department efficiency by requiring use of similar devices that are similarly configured. However, the administrative burden of enforcing standardization, especially as the non-centralized workforce expands and remote workers self-fulfill expanding equipment needs, is an undertaking that is expensive and one that consumes a substantial amount of an organization's IT resources.

### SUMMARY

Methods herein output (from a computer server) a rule menu and receive (back to the server) office equipment rules of an organization in response to outputting the rule menu. The office equipment rules include office equipment configuration settings. In response to receipt of the office equipment rules, with such methods the computer server configures at least one office equipment application that satisfies the office equipment rules.

The office equipment rules include restrictions on office equipment allocations. Thus, the process of configuring the office equipment application restricts equipment and supplies that are available for ordering based on the restrictions on office equipment allocations.

Also, the process of configuring the office equipment application can be controlled by the office equipment rules to cause different versions of the office equipment application to be configured to provide different equipment and supplies offerings and different configuration settings to different users associated with the organization. Similarly, the process of configuring the office equipment application can be controlled by the office equipment rules to cause different versions of the office equipment application to be configured to provide different access rights to organization resources for different users associated with the organization.

With the methods herein, the computer server supplies the office equipment application to at least one computerized device of at least one user associated with the organization. In these methods, the computer server receives an equipment/supplies order from the office equipment application. In response to receipt of the equipment/supplies order, the computer server generates order instructions. The order instructions include a list of equipment/supplies, a delivery address, the office equipment configuration settings for components on the list of equipment/supplies, etc. The order instructions are generated to comply with the office equipment rules.

With methods herein, the computer server identifies the delivery and setup agent based on an ability to deliver the list of equipment/supplies to the delivery address and an ability to configure the components on the list of equipment/supplies according to the office equipment configuration settings. Further, the process of configuring the office equipment application is controlled by the office equipment rules to cause different versions of the office equipment application to be configured to provide delivery and setup agents having different quality rankings and/or experience levels for different users associated with the organization.

With methods herein the computer server transmits the order instructions to a delivery and setup agent. In methods herein, the computer server schedules delivery and configuration of the components on the list of equipment/supplies based on availability of the delivery and setup agent and the user associated with the organization.

Systems herein utilize (among other components) a computer server that is adapted to output a rule menu and receive in response office equipment rules of an organization. The office equipment rules include office equipment configuration settings. The computer server is also adapted to configure at least one office equipment application that satisfies the office equipment rules.

The office equipment rules can include restrictions on office equipment allocations. Thus, the office equipment application can be configured by the computer server to restrict equipment and supplies available for ordering based on the restrictions on office equipment allocations. The office equipment application can also be configured by the computer server as controlled by the office equipment rules to cause different versions of the office equipment application to provide different equipment and supplies offerings and different configuration settings to different users associated with the organization. The office equipment application can be further configured by the computer server as controlled by the office equipment rules to cause different versions of the office equipment application to provide different access rights to organization resources for different users associated with the organization.

The computer server is adapted to supply the office equipment application to at least one computerized device of at least one user associated with the organization. In response, the computer server is adapted to receive, from the office equipment application, an equipment/supplies order. From this, the computer server is adapted to generate order instructions. The order instructions include a list of equipment/supplies and the office equipment configuration settings for components on the list of equipment/supplies. The order instructions are generated to comply with the office equipment rules.

The computer server is adapted to transmit the order instructions to a delivery and setup agent and schedule delivery and configuration of the components on the list of equipment/supplies based on availability of the delivery and setup agent and the user associated with the organization.

The computer server is adapted to identify the delivery and setup agent based on an ability to deliver the list of equipment/supplies to the delivery address and an ability to configure the components on the list of equipment/supplies according to the office equipment configuration settings. The office equipment application can be configured by the computer server as controlled by the office equipment rules to cause different versions of the office equipment application to provide differently quality-ranked delivery and setup agents for different users associated with the organization.

These and other features are described in, or are apparent from, the following detailed description.

### BRIEF DESCRIPTION OF THE DRAWINGS

Various exemplary systems and methods are described in detail below, with reference to the attached drawings, in which:

FIG. 1 is a schematic diagram illustrating systems herein;

FIG. 2 is a flow diagram of various methods herein;

FIG. 3 is a schematic diagram illustrating systems herein; and

FIG. 4 is a schematic diagram illustrating devices herein.

### DETAILED DESCRIPTION

As mentioned above, remote workers often lack access to quality office equipment that is correctly configured to their needs and meets corporate security standards. In view of this, systems and methods herein offer remote workers easy-to-order, pre-configured office equipment and tech support, making at-home work more productive and secure. With systems and methods herein, the required office equipment is selected and ordered from a simple, web-based app. Ordering can be done by an employee or by a parent organization. Then, product(s) are delivered by a tech savvy setup concierge. Products arrive pre-configured to each parent organization's IT specifications, including software and security. In-home concierge setup overcomes the potential for any technical or integration challenges. Customers can also determine the level of on-going support they need: supplies, service, etc.

With systems and methods herein, employers ensure workers are as productive as possible, while also staying in compliance with corporate information technology (IT) and security mandates. The systems and methods herein provide the opportunity for hardware/software equipment leasing and licensing, supplies replenishment, product hardware service, IT and security, etc.

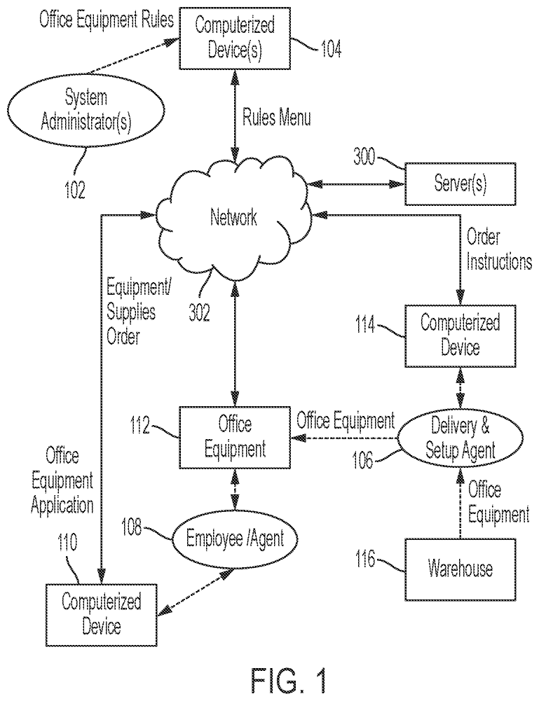

FIG. 1 is schematic diagram illustrating systems herein. FIG. 1 generally illustrates a network 302 (which can be a centralized local area network, a decentralized network, a wide area network, etc.). Various computerized devices are connected to one another through the network 302 including a system administrator's computerized device 104, a server 300, a delivery and setup agent's computerized device 114, office equipment 112, an employee/agent's computerized device 110, etc.

As shown in FIG. 1, a rule menu can be output from the computer server 300. For example, the rule menu can be supplied to or accessed by an organization that desires to standardize its office equipment offerings to employees/agents 108 who may be at many remote and/or office-based locations. The rule menu can include menu options that allow the organization to select specific equipment model numbers that are appropriate, security settings that are required, equipment usage patterns that are allowed and prohibited, etc.

When using the rule menu to set the organization's office equipment rules, a system administrator 102 of the organization (operating through their computerized device 104) can identify which equipment/supplies various employees/agents (or classes/groups thereof) can order and the system administrator 102 can specify the configuration settings for such equipment/supplies. Therefore, having the system administrator 102 interact with the rule menu on a computerized device 104 allows organizations to establish different lists of equipment/supplies based on an employees'/agents' need, their position within the organization, their budget, their expected productivity gains, etc.

In addition, the organization can use the rule menu to establish configuration settings for the different equipment items within the office equipment rules. This allows the organization to not only establish how the equipment/supplies should be best used and best connect to network resources, but also to establish how many features of the equipment/supplies are available to a given employee/agent (or class/group thereof). This allows the organization to control costs of supplies for example by restricting (for some employees/agents) color printing, high ink/toner usage, higher paper usage, etc. and to extend life expectancies of the equipment (e.g., by limiting equipment/supplies usage, etc.).

As show in FIG. 1, the server receives such office equipment rules of the organization in response to outputting the rule menu (e.g., from the computerized device 104 and through the network 302). As noted, the office equipment rules can include office equipment/supplies lists and office equipment configuration settings. In response to receipt of the office equipment rules, the computer server 300 creates/configures at least one office equipment application that satisfies the office equipment rules. In some examples, the computer server 300 can maintain a shell app and configure the app for the organization by automatically populating the app with the office equipment rules to thereby generate an organization-specific app.

Thus, a unique office equipment application can be created and/or configured for each organization based on that organization's office equipment rules received. The office equipment application is a computer application (series of logical instructions performable by a computerized device/system) and can take the form of an app for portable devices and personal computers, the form of an interactive web site, can take the form of a local area network interactive operation accessible by network-connected devices, and/or any other useful form, etc.

As noted above, the office equipment rules can include restrictions on office equipment/supplies allocations. Thus, the process of configuring the office equipment application can restrict equipment and supplies that are available for ordering based on those restrictions on office equipment/supplies allocations.

Also, the process of configuring the office equipment application can be controlled by the office equipment rules to cause different versions of the office equipment application to be configured to provide different equipment and supplies offerings and different configuration settings to different users associated with the organization. Similarly, the process of configuring the office equipment application can be controlled by the office equipment rules to cause different versions of the office equipment application to be configured to provide different access rights to organization resources (e.g., network-connected resources, etc.) for different users associated with the organization.

Once configured, the computer server 300 supplies the office equipment application to at least one computerized device 110 of at least one user 108 associated with the organization. Periodically the computer server 300 receives (through the network 302) an equipment/supplies order from the office equipment application, as shown in FIG. 1.

In response to receipt of the equipment/supplies order, the computer server 300 generates order instructions. The order instructions generated include a list of model specific equipment/supplies (specifying how each item is to be configured, which may be different for different employees/agents), a delivery address, the office equipment configuration settings for components on the list of equipment/supplies, etc. The order instructions are generated to comply with the office equipment rules. The configuration settings can, for example, set whether a user can print in color, print single sided, etc., set limits on number of prints per week or per month, set limits on what times of day the equipment can be used, limit which organization resources can be accessed, establish security and network settings, etc.

The computer server 300 identifies a delivery and setup agent 106 based on the agent's ability to deliver the list of equipment/supplies to the delivery address and the agent's ability to configure the components on the list of equipment/supplies according to the office equipment configuration settings. Further, the process of configuring the office equipment application is controlled by the office equipment rules to cause different versions of the office equipment application to be configured to provide differently quality-ranked delivery and setup agents for different users associated with the organization.

Therefore, if certain employees/agents (or classes/groups thereof) are flagged for an unusually high quality delivery agent interaction (e.g., because of employee lack of technical expertise, employee productivity requirements, employee organizational hierarchy importance ranking, etc.) such employee/agents may only be assigned delivery and setup agents who have a high level of experience, a high level of positive feedback/ranking from previous deliveries/setups, a certain amount of specialized training, etc.

The computer server 300 also schedules delivery and configuration of the components on the list of equipment/supplies based on the availability of the delivery and setup agent 106 and the employee/agent 108 that placed the order. In one example, equipment can be ordered from a manufacturer to be configured as specified in the order instructions. In another example, generic equipment can be ordered and the delivery and setup agent or other technician can configure the generic equipment as specified in the order instructions.

As shown in FIG. 1, the computer server 300 transmits the order instructions to the selected delivery and setup agent 106. In response, the delivery and setup agent 106 obtains the office equipment from a warehouse 116 and delivers the office equipment 112 to the address of the employee/agent 108. The delivery and setup agent 106 makes the office equipment fully operable (through physical setup, configuration, operational testing, employee/agent equipment usage training, etc., as required in the order instructions). The delivery and setup agent 106 configures the equipment 112 according to the order instructions and provides any needed training to the employee/agent 108.

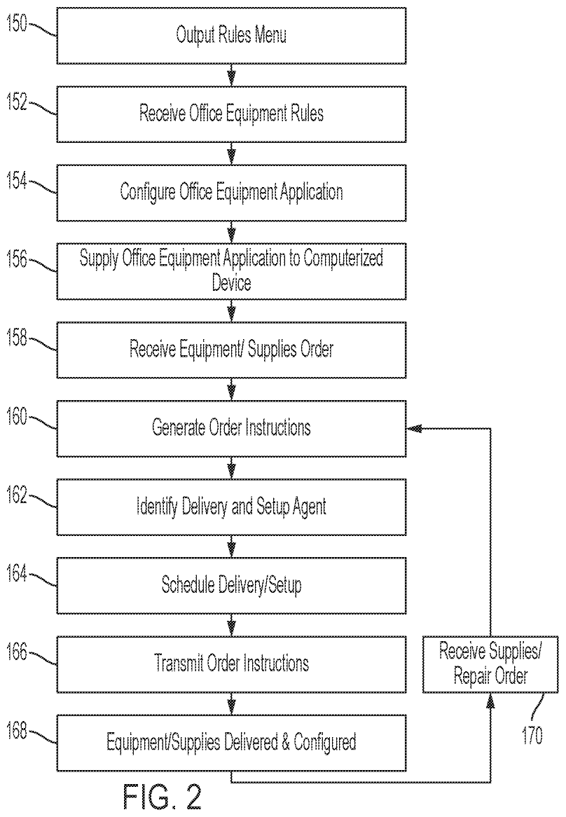

FIG. 2 is flowchart illustrating exemplary methods herein. In item 150, these methods output (from a computer server) a rule menu. For example, the rule menu can be supplied to an organization that desires to standardize its office equipment offerings to employees/agents who may be at many remote and/or office-based locations.

When using the rule menu to set the organization's office equipment rules, the organization can identify which equipment/supplies various employees/agents or classes of employees/agents can order and specify the configuration settings for such equipment/supplies. Therefore, the rule menu allows organizations to establish different lists of equipment/supplies based on an employees'/agents' need, their position within the organization, their budget, their expected productivity gains, etc.

In addition, the organization can use the rule menu to establish configuration settings for the different equipment items within the office equipment rules. This allows the organization to not only establish how the equipment/supplies should be best used or best be connected to network resources, but also to establish how many features of the equipment/supplies are available to a given employee/agent or class of employees/agents. This allows the organization to control costs of supplies (e.g., by restricting color printing, high ink/toner usage, higher paper usage, etc.) and to extend life expectancies of the equipment (e.g., by limiting equipment/supplies usage, etc.).

In item 152 in FIG. 2, the methods herein receive such office equipment rules of the organization in response to outputting the rule menu. As noted, the office equipment rules can include office equipment/supplies lists and office equipment configuration settings. In response to receipt of the office equipment rules, as shown in item 154 with such methods the computer server configures at least one office equipment application that satisfies the office equipment rules.

A unique office equipment application can be created and/or configured in item 154 for each organization based on that organization's office equipment rules received in item 152. The office equipment application is a computer application (series of logical instructions performable by a computerized device/system) and can take the form of an app for portable devices and personal computers, the form of an interactive web site, can take the form of a local area network interactive operation accessible by network-connected devices, or any other useful form, etc.

As noted above, the office equipment rules can include restrictions on office equipment/supplies allocations. Thus, the process of configuring the office equipment application in item 154 can restrict equipment and supplies that are available for ordering based on those restrictions on office equipment/supplies allocations.

Also, the process of configuring the office equipment application in item 154 can be controlled by the office equipment rules to cause different versions of the office equipment application to be configured to provide different equipment and supplies offerings and different configuration settings to different users associated with the organization. Similarly, the process of configuring the office equipment application in item 154 can be controlled by the office equipment rules to cause different versions of the office equipment application to be configured to provide different access rights to organization resources (e.g., network-connected resources, etc.) for different users associated with the organization.

Once configured in item 154, the computer server supplies the office equipment application to at least one computerized device of at least one user associated with the organization in item 156. In these methods, periodically the computer server receives an equipment/supplies order from the office equipment application, as shown in item 158 in FIG. 2.

In response to receipt of the equipment/supplies order, the computer server generates order instructions in item 160. The order instructions generated in item 160 include a list of equipment/supplies, a delivery address, the office equipment configuration settings for components on the list of equipment/supplies, etc. The order instructions are generated in item 160 to comply with the office equipment rules.

With methods herein, in item 162 the computer server identifies a delivery and setup agent based on the agent's ability to deliver the list of equipment/supplies to the delivery address and the agent's ability to configure the components on the list of equipment/supplies according to the office equipment configuration settings. Further, the process of configuring the office equipment application in item 154 is controlled by the office equipment rules to cause different versions of the office equipment application to be configured to provide differently quality-ranked delivery and setup agents for different users associated with the organization.

Therefore, if certain employees/agents (or classes/groups thereof) are flagged for an unusually high quality delivery agent interaction (e.g., because of employee lack of technical expertise, employee productivity requirements, employee organizational hierarchy importance ranking, etc.) in item 162 such employee/agents may only be assigned delivery and setup agents who have a certain level of experience, a certain level of positive feedback/ranking from previous deliveries/setups, a certain amount of specialized training, etc.

In methods herein, in item 164 the computer server schedules delivery and configuration of the components on the list of equipment/supplies based on the availability of the delivery and setup agent and the user associated with the organization that placed the order. With method herein the computer server transmits the order instructions to the selected delivery and setup agent in item 166 who delivers and configures the equipment/supplies in item 168.

After delivery and setup, the employee/agent may experience problems and/or need supplies to be replenished. Using the office equipment application, the employee/agent can request service, order supplies, order more equipment, etc.; and, as shown in item 170, the server receives such a supply/repair order. The office equipment application again is limited by the office equipment rules, which limits the type of supplies and repairs that can be requested by the employee/agent. In some examples in item 170, the app may limit the supplies employees/agents can order each month, to prevent budgets from being exceeded and discourage non-work use of the equipment. In other examples in item 170, the app may require that some equipment be replaced with new equipment rather than being serviced/repaired, based on previously established cost/benefit standards. Then, processing returns to item 160 where the server generates order instructions for the repair/supply order.

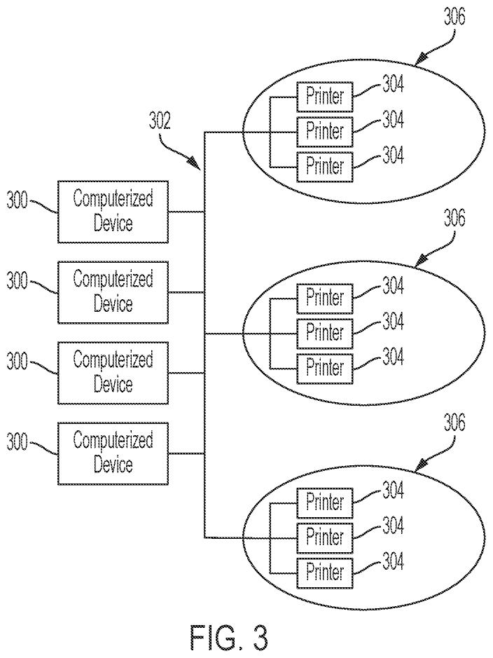

As shown in FIG. 3, exemplary systems and methods herein include various computerized devices 300, 304 located at various different physical locations 306. The computerized devices 300, 304 can include print servers, printing devices, personal computers, etc., and are in communication (operatively connected to one another) by way of a local or wide area (wired or wireless) network 302.

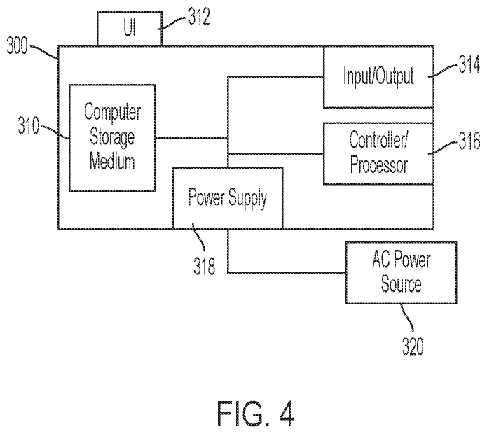

FIG. 4 illustrates a computerized device 300, which can be used with systems and methods herein and can comprise, for example, a print server, a personal computer, a portable computing device, etc. The computerized device 300 includes a controller/tangible processor 316 and a communications port (input/output) 314 operatively connected to the tangible processor 316 and to the computerized network 302 external to the computerized device 300. Also, the computerized device 300 can include at least one accessory functional component, such as a user interface (UI) assembly 312. The user may receive messages, instructions, and menu options from, and enter instructions through, the user interface or control panel 312.

The input/output device 314 is used for communications to and from the computerized device 300 and comprises a wired device or wireless device (of any form, whether currently known or developed in the future). The tangible processor 316 controls the various actions of the computerized device. A non-transitory, tangible, computer storage medium device 310 (which can be optical, magnetic, capacitor based, etc., and is different from a transitory signal) is readable by the tangible processor 316 and stores instructions that the tangible processor 316 executes to allow the computerized device to perform its various functions, such as those described herein. Thus, as shown in FIG. 4, a body housing has one or more functional components that operate on power supplied from an alternating current (AC) source 320 by the power supply 318. The power supply 318 can comprise a common power conversion unit, power storage element (e.g., a battery, etc), etc.

Many computerized devices are discussed above. Computerized devices that include chip-based central processing units (CPU's), input/output devices (including graphic user interfaces (GUI), memories, comparators, tangible processors, etc.) are well-known and readily available devices produced by manufacturers such as Dell Computers, Round Rock Tex., USA and Apple Computer Co., Cupertino Calif., USA. Such computerized devices commonly include input/output devices, power supplies, tangible processors, electronic storage memories, wiring, etc., the details of which are omitted herefrom to allow the reader to focus on the salient aspects of the systems and methods described herein. Similarly, printers, copiers, scanners and other similar peripheral equipment are available from Xerox Corporation, Norwalk, Conn., USA and the details of such devices are not discussed herein for purposes of brevity and reader focus.

The terms printer or printing device as used herein encompasses any apparatus, such as a digital copier, bookmaking machine, facsimile machine, multi-function machine, etc., which performs a print outputting function for any purpose. The details of printers, printing engines, etc., are well-known and are not described in detail herein to keep this disclosure focused on the salient features presented. The systems and methods herein can encompass systems and methods that print in color, monochrome, or handle color or monochrome image data. All foregoing systems and methods are specifically applicable to electrostatographic and/or xerographic machines and/or processes.

Further, the term “app” (or “application”) describes one or more methodologies or processes performed using computerized devices and such apps can be embodied in software, firmware, hardware, etc. Therefore, apps herein are one or more sets of instructions embodied in languages machines can understand that direct a computerized device to perform or stop some action. The apps herein can, for example: direct computerized devices to display items on user interfaces that users can interact with; direct computerized devices to communicate with and transfer data between other devices over computerized networks; direct processes to automatically begin or end and direct the computerized devices to perform each of the individual steps of such processes automatically; direct computerized devices to store data, delete data, perform computations using data, etc.; and/or direct computerized devices to set and monitor timers; etc.

In addition, the terms automated or automatically mean that once a process is started (by a machine or a user), one or more machines perform the process without further input from any user. Additionally, terms such as “adapted to” mean that a device is specifically designed to have specialized internal or external components that automatically perform a specific operation or function at a specific point in the processing described herein, where such specialized components are physically shaped and positioned to perform the specified operation/function at the processing point indicated herein (potentially without any operator input or action). In the drawings herein, the same identification numeral identifies the same or similar item.

While some exemplary structures are illustrated in the attached drawings, those ordinarily skilled in the art would understand that the drawings are simplified schematic illustrations and that the claims presented below encompass many more features that are not illustrated (or potentially many less) but that are commonly utilized with such devices and systems. Therefore, Applicants do not intend for the claims presented below to be limited by the attached drawings, but instead the attached drawings are merely provided to illustrate a few ways in which the claimed features can be implemented.

It will be appreciated that the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims. Unless specifically defined in a specific claim itself, steps or components of the systems and methods herein cannot be implied or imported from any above example as limitations to any particular order, number, position, size, shape, angle, color, or material.

What is claimed is:

1. A method comprising:
receiving, by a computer server, office equipment rules of an organization, wherein the office equipment rules include office equipment configuration settings;
configuring, by the computer server, at least one office equipment application that satisfies the office equipment rules;
supplying, by the computer server, the office equipment application to at least one computerized device of at least one user associated with the organization;
receiving, by the computer server from the office equipment application, an equipment/supplies order;
generating, by the computer server, order instructions, wherein the order instructions include a list of equipment/supplies and the office equipment configuration settings for components on the list of equipment/supplies, and wherein the order instructions are generated to comply with the office equipment rules; and
transmitting, by the computer server, the order instructions to a delivery and setup agent.

2. The method according to claim 1, wherein the office equipment rules include restrictions on office equipment allocations, and wherein the configuring of the office equipment application restricts equipment and supplies available for ordering based on the restrictions on office equipment allocations.

3. The method according to claim 1, wherein the configuring of the office equipment application is controlled by the office equipment rules to cause different versions of the office equipment application to be configured to provide different equipment and supplies offerings and different configuration settings to different users associated with the organization.

4. The method according to claim 1, further comprising identifying, by the computer server, the delivery and setup agent based on an ability to deliver the list of equipment/supplies to a delivery address and an ability to configure the components on the list of equipment/supplies according to the office equipment configuration settings.

5. The method according to claim 4, wherein the configuring of the office equipment application is controlled by the office equipment rules to cause different versions of the office equipment application to be configured to provide differently quality-ranked delivery and setup agents for different users associated with the organization.

6. The method according to claim 1, wherein the configuring of the office equipment application is controlled by the office equipment rules to cause different versions of the office equipment application to be configured to provide different access rights to organization resources for different users associated with the organization.

7. The method according to claim 1, further comprising scheduling, by the computer server, delivery and configuration of the components on the list of equipment/supplies based on availability of the delivery and setup agent and the user associated with the organization.

8. A method comprising:
outputting, by a computer server, a rule menu;
receiving, by the computer server in response to outputting the rule menu, office equipment rules of an organization, wherein the office equipment rules include office equipment configuration settings;
configuring, by the computer server in response to receipt of the office equipment rules, at least one office equipment application that satisfies the office equipment rules;
supplying, by the computer server, the office equipment application to at least one computerized device of at least one user associated with the organization;
receiving, by the computer server from the office equipment application, an equipment/supplies order;
generating, by the computer server in response to receipt of the equipment/supplies order, order instructions, wherein the order instructions include a list of equipment/supplies, a delivery address, and the office equipment configuration settings for components on the list of equipment/supplies, and wherein the order instructions are generated to comply with the office equipment rules; and
transmitting, by the computer server, the order instructions to a delivery and setup agent.

9. The method according to claim 8, wherein the office equipment rules include restrictions on office equipment allocations, and wherein the configuring of the office equipment application restricts equipment and supplies available for ordering based on the restrictions on office equipment allocations.

10. The method according to claim 8, wherein the configuring of the office equipment application is controlled by the office equipment rules to cause different versions of the office equipment application to be configured to provide different equipment and supplies offerings and different configuration settings to different users associated with the organization.

11. The method according to claim 8, further comprising identifying, by the computer server, the delivery and setup agent based on an ability to deliver the list of equipment/supplies to the delivery address and an ability to configure the components on the list of equipment/supplies according to the office equipment configuration settings.

12. The method according to claim 11, wherein the configuring of the office equipment application is controlled by the office equipment rules to cause different versions of the office equipment application to be configured to provide differently quality-ranked delivery and setup agents for different users associated with the organization.

13. The method according to claim 8, wherein the configuring of the office equipment application is controlled by the office equipment rules to cause different versions of the office equipment application to be configured to provide different access rights to organization resources for different users associated with the organization.

14. The method according to claim 8, further comprising scheduling, by the computer server, delivery and configuration of the components on the list of equipment/supplies based on availability of the delivery and setup agent and the user associated with the organization.

15. A system comprising:
a computer server, wherein the computer server is adapted to:
receive office equipment rules of an organization, wherein the office equipment rules include office equipment configuration settings,
configure at least one office equipment application that satisfies the office equipment rules,
supply the office equipment application to at least one computerized device of at least one user associated with the organization,
receive, from the office equipment application, an equipment/supplies order,
generate order instructions, wherein the order instructions include a list of equipment/supplies and the office equipment configuration settings for components on the list of equipment/supplies, and wherein the order instructions are generated to comply with the office equipment rules, and
transmit the order instructions to a delivery and setup agent.

16. The system according to claim 15, wherein the office equipment rules include restrictions on office equipment allocations, and wherein the office equipment application is configured by the computer server to restrict equipment and supplies available for ordering based on the restrictions on office equipment allocations.

17. The system according to claim 15, wherein the office equipment application is configured by the computer server as controlled by the office equipment rules to cause different versions of the office equipment application to provide different equipment and supplies offerings and different configuration settings to different users associated with the organization.

18. The system according to claim 15, wherein the computer server is adapted to identify the delivery and setup agent based on an ability to deliver the list of equipment/supplies to a delivery address and an ability to configure the components on the list of equipment/supplies according to the office equipment configuration settings.

19. The system according to claim 18, wherein the office equipment application is configured by the computer server as controlled by the office equipment rules to cause different versions of the office equipment application to provide differently quality-ranked delivery and setup agents for different users associated with the organization.

20. The system according to claim 15, wherein the office equipment application is configured by the computer server as controlled by the office equipment rules to cause different versions of the office equipment application to provide different access rights to organization resources for different users associated with the organization.
